(19) United States
(12) Patent Application Publication
(10) Pub. No.: US 2010/0141170 A1
(43) Pub. Date: Jun. 10, 2010

(54) AC/DC MODULATION CONVERSION SYSTEM AND APPLICATION THEREOF

(76) Inventors: Ching-Sheng YU, Wugu Township (TW); Yi-Chang LEU, Jhonghe City (TW); Hsin-Yi LEE, Jhonghe City (TW)

Correspondence Address: Muncy, Geissler, Olds & Lowe, PLLC, 4000 Legato Road, Suite 310, FAIRFAX, VA, 22033, US

(21) Appl. No.: 12/634,072

(22) Filed: Dec. 9, 2009

(30) Foreign Application Priority Data
Dec. 9, 2008 (TW) 97147903

(51) Int. Cl. H05B 37/02; H02M 7/42

(52) U.S. Cl. 315/291; 363/74

(57) ABSTRACT

This invention discloses an AC/DC modulation conversion system, which comprises a control signal transmitter, a control signal receiver and a control signal/modulation signal converter. The control signal transmitter transmits a control signal, the control signal receiver receives the control signal, the control signal/modulation signal converter converts the control signal into a pulse width modulation signal or a DC level modulation signal. Therefore, this AC/DC modulation conversion system can be applied to controllable DC load circuits such as a controllable DC heater, a controllable DC motor or a controllable DC lamp etc for respectively controlling the temperature, speed or brightness etc.

### BACKGROUND OF THE INVENTION

1. Field of Invention

The present invention relates to an AC/DC modulation conversion system, which can be applied to modulate controllable DC load circuits, such as to control the temperature of a controllable DC heater, the speed of a controllable DC motor and the lightness of a controllable DC lamp.

2. Related Art

FIG. 1 shows a circuit schematic diagram of a sinusoidal voltage chopper, and the input terminal Vᵢ and input reference ground Vᵣᵢ are connected to an input voltage source, which provides a voltage with sine wave. The output terminal Vₒ and the output reference ground are respectively connected to an alternative load. A variable resistor R₁ and a capacitor C₁ are connected to form a firing delay circuit. A variable resistor R₂ and a capacitor C₂ are connected to form a lowpass filter. D₁ is a diode for alternating current (DIAC) and Q_{c} is a triode for alternating current (TRIAC).

FIG. 2A and FIG. 2B respectively show the equivalent circuit and characteristic curve of a DIAC, D₁. A DIAC is equivalent to two Shockley diodes connected in anti-parallel. From the characteristic curve, D₁ is turned on when the cross voltage of D₁ is over the breakdown voltage |V_{B}|, and D₁ is cut off when the current passing D₁ is smaller than the holding current, |I_{H}|.

FIG. 3A and FIG. 3B respectively show the equivalent circuit and the characteristic curve of a TRIAC, Q_{c}. A TRIAC is equivalent to two silicon-controlled rectifiers (SRCs) connected in anti-parallel. From the characteristic curve, the gate current |I_{G}| is larger and the breakdown voltage |V_{B}| is lower, shown as (|I_{G2}|>|I_{G1}|>|I_{G0}|→|V_{B0}|>|V_{B1}|>|V_{B2}|). Q_{c} is turned on when the cross voltage of Q_{c} is higher than the breakdown voltage |V_{B}|, and Q_{c} is cut off when the current passing Q_{c} is smaller than the holding current, |I_{H}|.

FIG. 4 shows the waveform of the output voltage, vₒ(t), a sinusoidal voltage chopper. During firing delay time, 0≦t≦(α/ω)), the voltage of capacitor C₁ is equivalent to or lower than the breakdown voltage V_{B} of the D₁, so D₁ and Q_{c} are cut off and vₒ(t)=0. During conduction time, (α/ω)≦t≦(π/ω), the voltage of capacitor C₁ is equivalent to or higher than the breakdown voltage V_{B} of the D₁, so D₁ and Q_{c} are turned on and vₒ(t)=vᵢ(t). The waveform of later half period is symmetric to that of the fore half period.

The root-mean-squared voltage Vᵣₘₛ of the output voltage vₒt) is expressed as follows

$${V}_{rms} = \sqrt{\frac{1}{T / 2} {\int }_{α / ω}^{π / ω} {V}_{pk}^{2} {sin}^{2} ( ω t ) d t} = {V}_{pk} \sqrt{\frac{2 ( π - α ) + sin ( 2 α )}{4 π}}$$

where T is the period, ω=(2π/T) is angular frequency, ≦ is firing delay angle and Vₚₖ is the peak voltage of vₒ(t). α decreases and Vᵣₘₛ increases when R₁ reduces; α increases and Vᵣₘₛ decreases when R₁ increases.

In general, the sinusoidal voltage chopper is applied to control temperature, speed and lightness etc. of an alternative load circuit. That is also called an AC light dimmer when applied to control the lightness. In some traditional building, the AC light dimmer is generally applied to modulate an alternative lamp, such as a fluorescent lamp, an incandescent lamp and so on. The above-mentioned lamps have disadvantages of low lighting efficiency. For energy conservation and carbon reduction, high lighting efficiency lamps appear continuously, such as a halogen lamp, a light emitting diode (LED) and so on. However, these high efficiency lamps are driven by direct voltage/current, so the AC lighting dimmer cannot be applied directly.

### SUMMARY OF THE INVENTION

The present invention discloses an AC/DC modulation conversion system, which can be directly, or through a sinusoidal voltage chopper, applied to control a DC load circuit, such as to control the temperature of a DC heater, the speed of a DC motor or the lightness of a DC lamp.

The AC/DC modulation conversion system comprises a control signal transmitter, a control signal receiver and a control/modulation signal converter. The control signal transmitter senses the amplitude of the input voltage to emit a control signal, and the signal receiver receives the control signal to drive the control/modulation signal converter to convert the control signal into a modulation signal. The modulation signal can be a PWM modulation signal or a voltage level modulation signal to modulate a controllable DC load circuit.

### BRIEF DESCRIPTION OF THE DRAWINGS

FIG. 1 shows a schematic circuit of a sinusoidal voltage chopper.

FIG. 2A and FIG. 2B respectively show the equivalent circuit and the characteristic curve of the DIAC D₁ shown in FIG. 1.

FIG. 3A and FIG. 3B respectively show the equivalent circuit and the characteristic curve of the TRIAC Q_{c} shown in FIG. 1.

FIG. 4 shows the waveform of the output voltage of a sinusoidal voltage chopper.

FIG. 5 shows a schematic architecture of an AC/DC modulation conversion system according to an embodiment of the present invention.

FIG. 6 shows the first embodiment of the control signal transmitter U_{T} and the control signal receiver U_{R} in FIG. 5.

FIG. 7 shows the second embodiment of the control signal transmitter U_{T} and the control signal receiver U_{R} in FIG. 5.

FIG. 8 shows an embodiment of the control/modulation signal converter U_{C} in FIG. 5.

FIG. 9 shows the block diagram of the structure of the voltage regulator T_{C2} in FIG. 8.

FIG. 10 shows the waveforms of the input voltage of the control signal transmitter U_{T} and the output voltage of the control/modulation signal converter.

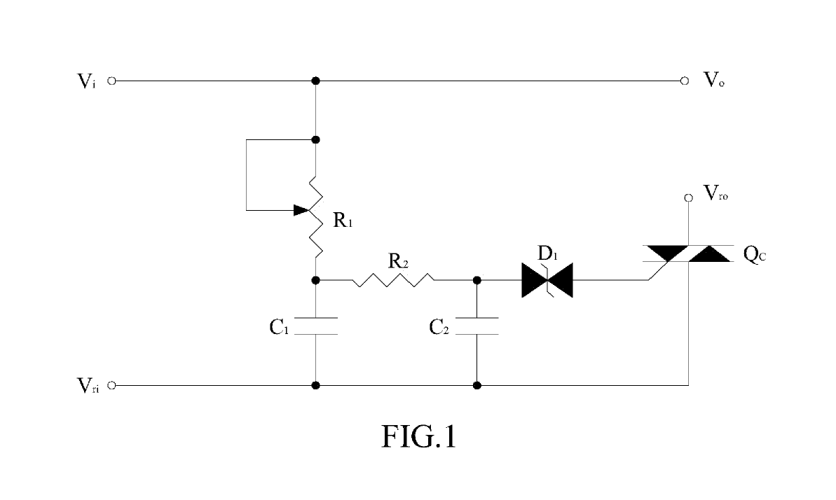

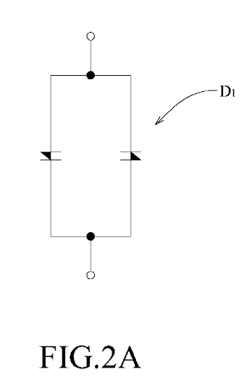

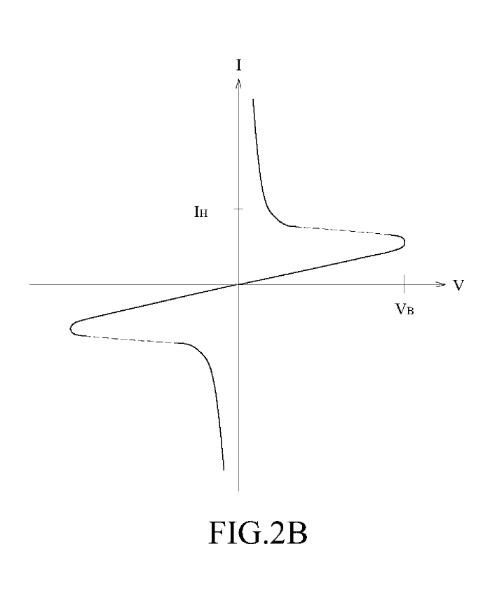

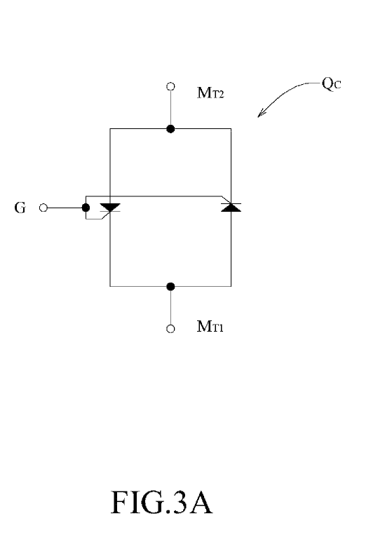

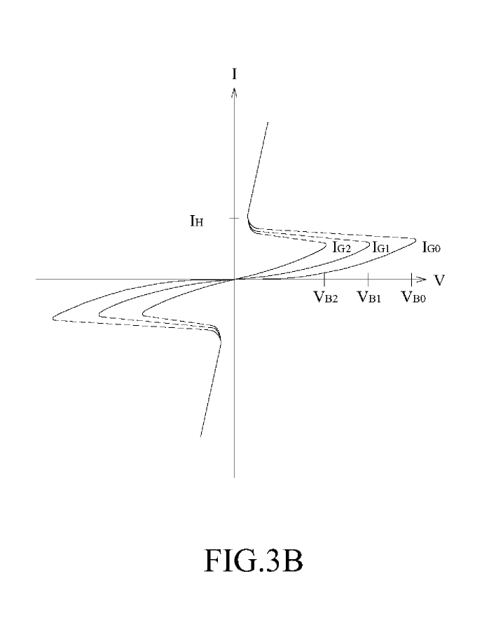

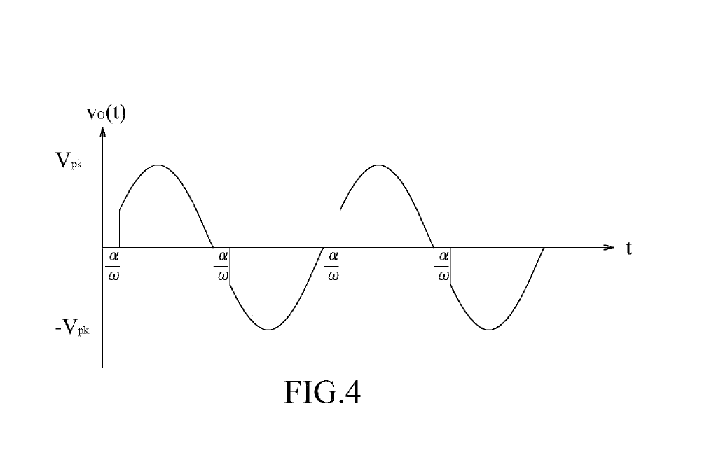

### DETAILED DESCRIPTION OF THE INVENTION

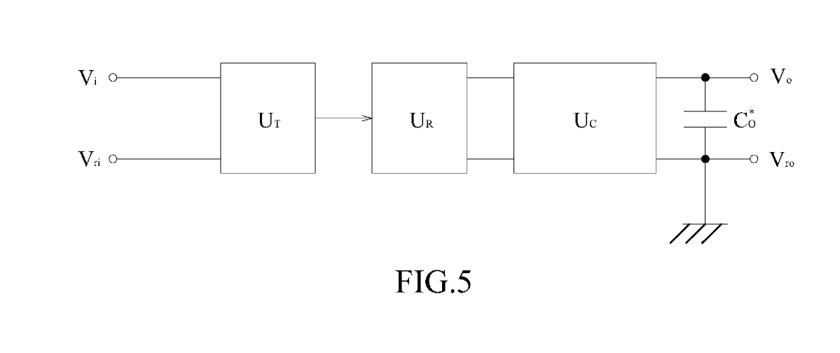

FIG. 5 shows the architecture of an AC/DC modulation conversion system according to the present invention. The system comprises a control signal transmitter U_{T}, a control signal receiver U_{R} and a control/modulation signal converter U_{C}.

The input terminal Vᵢ and the input reference (input ground) Vᵣᵢ of control signal transmitter U_{T} are connected to an output of an alternative power source or a sinusoidal voltage chopper. The control signal transmitter U_{T} senses the amplitude of input voltage and emits a control signal.

The control signal receiver U_{R} communicates with the control signal transmitter U_{T} to receive the control signal, and drives the control/modulation signal converter U_{C} to convert the control signal into a pulse width modulation signal or a DC level modulation signal. The output terminal Vₒ and the output reference terminal (output ground) Vᵣₒ are respectively connected to a positive end and a negative end of a DC load circuit.

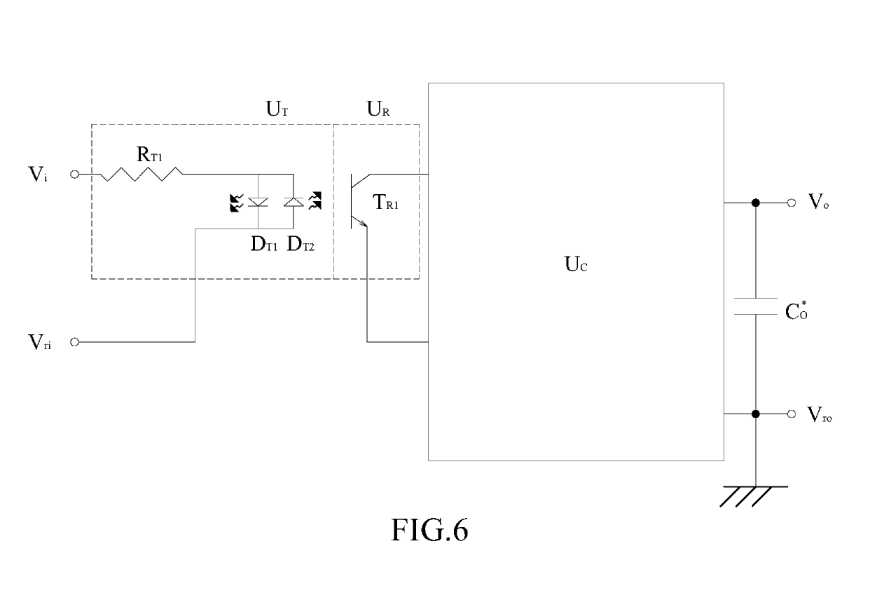

FIG. 6 shows a first embodiment of the control signal transmitter U_{T} and the control signal receiver U_{R}. The control signal transmitter U_{T} comprises a firing delay angle adjustment element R_{T1}, opto-diodes D_{T1} and D_{T2}. The opto-diodes D_{T1} and D_{T2} are connected in anti-parallel (the polarities of two opto-diodes are opposite) and then connected to the firing delay angle adjustment element R_{T1}. The control signal receiver U_{R} comprises an opto-transistor T_{R1}, which is connected to the input of the control/modulation signal converter U_{C}. The opto-diodes D_{T1} and D_{T2} and the opto-transistor T_{R1} are combined to form a bidirectional opto-coupler. The firing delay angle adjustment element R_{T1} may be a resistor or a controllable current source. In this embodiment, R_{T1} is a resistor.

During positive half period, the opto-diode D_{T1} is forward biased and turned on, but the opto-diode D_{T2} is reverse biased and cut off. The input current passes the opto-diode D_{T1} but not the opto-diode D_{T2}, so the opto-diode D_{T1} is excited by the input current to luminesce but not D_{T2}. During negative half period, the opto-diode D_{T2} is forward biased and turned on, but the opto-diode D_{T1} is reverse biased and cut off. The input current passes the opto-diode D_{T2} but not the opto-diode D_{T1}, so the opto-diode D_{T2} is excited by the input current to luminesce but not D_{T1}.

The forward current i_{F}(t) passing opto-diodes D_{T1} and D_{T2} is expressed as

$${i}_{F} ( t ) = \{ \begin{matrix}0 ; & \vert {v}_{i} ( t ) \vert < {V}_{F} \\ \frac{\vert {v}_{i} ( t ) \vert - {V}_{F}}{{R}_{T 1}} ; & \vert {v}_{i} ( t ) \vert \geq {V}_{F}\end{matrix}$$

where vᵢ(t) is the input voltage of the control transmitter U_{T}, and V_{F} is the forward voltage drop of the opto-diodes D_{T1} and D_{T2}. The collector current i_{C}(t) of the opto-transistor T_{R1} is expressed as

$${i}_{C} ( t ) = η {i}_{F} ( t ) = \{ \begin{matrix}0 ; & \vert {v}_{i} ( t ) \vert < {V}_{F} \\ \frac{η [ \vert {v}_{i} ( t ) \vert - {V}_{F} ]}{{R}_{T 1}} ; & \vert {v}_{i} ( t ) \vert \geq {V}_{F}\end{matrix}$$

where η is the current transfer ratio (CTR). The i_{C}(t) depends on vᵢ(t), and the opto-transistor T_{R1} behaves as a dependent current source.

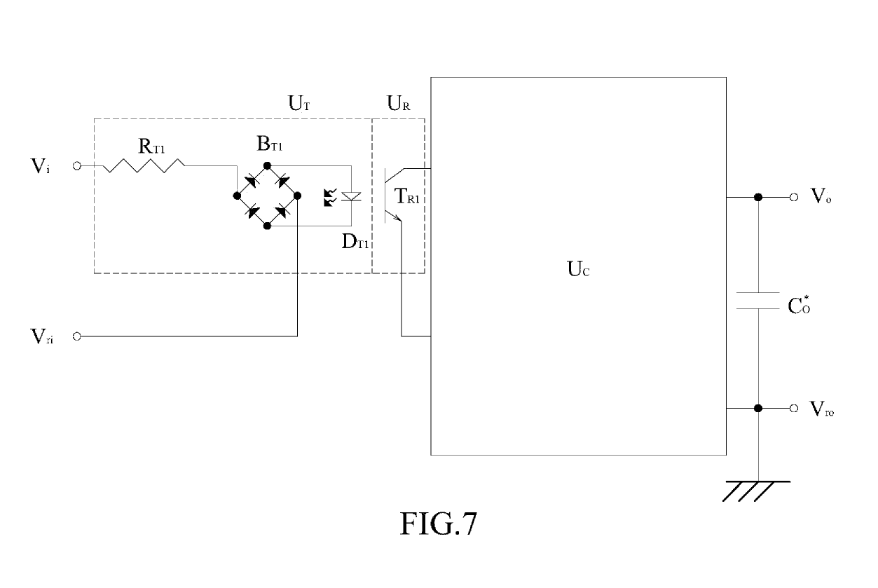

FIG. 7 shows an second embodiment of the control signal transmitter U_{T} and the control signal receiver U_{R}. the control signal transmitter U_{T} comprises a firing delay angle adjustment element R_{T1}, a bridge diode rectifier B_{T1} and an opto-diode D_{T1}, where the AC input of the bridge diode rectifier B_{T1} is connected to the firing delay angle adjustment element R_{T1} in series and the DC output of the bridge diode rectifier B_{T1} is connected to the opto-diode D_{T1} in parallel. The control signal receiver U_{R} comprises an opto-transistor T_{R1}, which is connected to the input of the control/modulation signal converter U_{C}. The opto-diode D_{T1} and opto-transistor T_{R1} are combined to form a unidirectional opto-coupler. Similar with the embodiment shown as FIG. 6, the firing delay angle adjustment element R_{T1} can be a resistor or a controllable current source, and in this embodiment that is a resistor.

During positive period, the upper left and the lower right diodes of the bridge diode rectifier B_{T1} are forward biased and turned on, but the upper right and the lower left diodes are reverse biased and cut off. During negative period, the upper right and the lower left diodes of the bridge diode rectifier B_{T1} are forward biased and turned on, but the upper left and the lower right diodes are reverse biased and cut off. Whatever the positive period or the negative period, the opto-diode D_{T1} is forward biased and turned on. The input current always passes and excites the opto-diode D_{T1} to luminesce.

The forward current i_{F}(t) passing opto-diodes D_{T1} is expressed as

$${i}_{F} ( t ) = \{ \begin{matrix}0 ; & \vert {v}_{i} ( t ) \vert < {V}_{F} + 2 {V}_{f} \\ \frac{\vert {v}_{i} ( t ) \vert - ( {V}_{F} + 2 {V}_{f} )}{{R}_{T 1}} ; & \vert {v}_{i} ( t ) \vert \geq {V}_{F} + 2 {V}_{f}\end{matrix}$$

where V_{f} is the voltage drop of one diode of the bridge diode rectifier B_{T1}. The collector current i_{C}(t) of the opto-transistor T_{R1} is expressed as

$${i}_{C} ( t ) = η {i}_{F} ( t ) = \{ \begin{matrix}0 ; & \vert {v}_{i} ( t ) \vert < {V}_{F} + 2 {V}_{f} \\ \frac{η [ \vert {v}_{i} ( t ) \vert - ( {V}_{F} + 2 {V}_{f} ) ]}{{R}_{T 1}} ; & \vert {v}_{i} ( t ) \vert \geq {V}_{F} + 2 {V}_{f}\end{matrix}$$

where η is the current transfer ratio (CTR). The i_{C}(t) depends on vᵢ(t), and the opto-transistor T_{R1} behaves as a dependent current source. It is emphatically noted that the input terminal and the input reference terminal of the control signal transmitter may be connected to an alternative current source (the firing delay angle α=0) or a sinusoidal voltage chopper (the firing delay angle 0≦π). In situation of α=0, the firing delay angle adjustment element R_{T1} may be a variable resistor, a controllable resistor of the combination thereof to achieve the function of DC modulation. In situation of 0≦π, the firing delay angle adjustment element R_{T1} may be replaced by a constant resistor since the variable resistor of the sinusoidal voltage chopper has the function of modulating the firing delay angle. According to the above, the firing delay angle adjustment element R_{T1} may be a constant resistor, a variable resistor, a controllable current source or the combination thereof and can achieve the function of DC modulation.

The communication between the control signal transmitter U_{T} and the control signal receiver U_{R} can be but not limited to opto-coupling, magneto-coupling or electro-coupling and so on. For better understanding, 0≦π and the communication of opto-coupling are assumed. Opto-diodes and an opto-transistor are respectively used as the control signal transmitter U_{T} (called an opto-transmitter) and the control signal receiver U_{R} (called an opto-receiver).

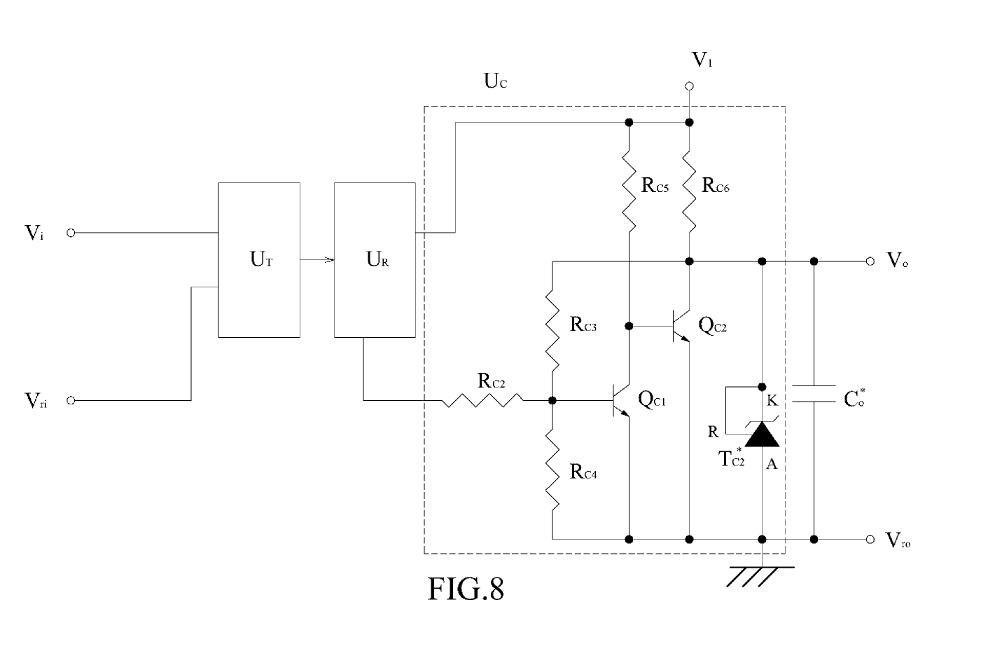

FIG. 8 is a circuit schematic diagram of a control/modulation signal converter U_{C} according an embodiment of the present invention. The control/modulation signal converter U_{C} comprises resistors R_{C2}, R_{C3}, R_{C4}, R_{C5}, R_{C6}, a filter capacitor Cₒ (optional), NPN bipolar junction transistors Q_{C1}, Q_{C2} and a programmable voltage regulator T_{C2} (optional).

The filter capacitor Cₒ and the programmable voltage regulator T_{C2} are optional and marked * in figures. Without the filter capacitor Cₒ but with the programmable voltage regulator T_{C2}, the control/modulation signal converter U_{C} converts the control signal into a PWM modulation signal. With the filter capacitor Cₒ but without the programmable voltage regulator T_{C2}, the control/modulation signal converter U_{C} converts the control signal into a level voltage modulation signal. For convenience, the situation of without the filter capacitor Cₒ but with the programmable voltage regulator T_{C2} is assumed.

Bipolar junction transistors Q_{C1}, Q_{C2} all have a base B, an emitter E and a Collector C. The V_{BE(sat)} and V_{CE(sat)} are respectively defined as the base-emitter (B-E) saturation voltage and the collector-emitter (C-E) saturation voltage. The bipolar junction transistors Q_{C1}, Q_{C2} are connected in series and form a voltage inverter.

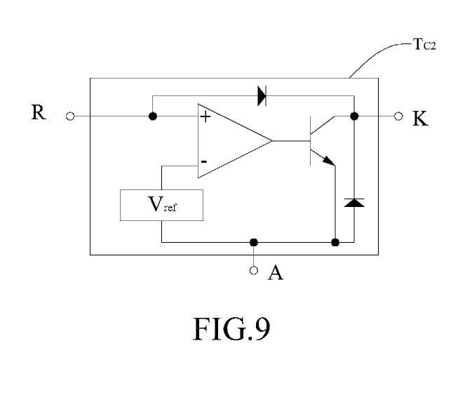

FIG. 9 is a block diagram showing the circuit schematic diagram of the programmable voltage regulator T_{C2}, which comprises a reference terminal R, an anode A, a cathode K and a reference voltage V_{ref}.

The base of the transistor Q_{C1} is connected to the emitter of the opto-transistor T_{R1} via the resistor R_{C2}, which is used to protect the B-E junction of the transistor Q_{C1} from damage caused by the over high B-E voltage V_{BE}. When the collector and the emitter of the opto-transistor T_{R1} is short (turned on) and the input voltage is directly used as the voltage V_{BE}, the voltage V_{BE} may be too high to destroy the B-E junction of the transistor Q_{C1}. When the resistor R_{C2} is connected, the input voltage will be reduced and provide a more safe V_{BE}.

Resistors R_{C3} and R_{C4} are connected in cascade between the output terminal Vₒ and the output reference terminal Vᵣₒ, the interconnection point of R_{C3} and R_{C4} is connected to the base of the transistor Q_{C1} and construct a voltage divider of the B-E junction of the transistor Q_{C1}.

One end of the resistor R_{C5} is connected to an independent voltage source V₁ and the other end of the resistor R_{C5} is connected to the collector of the transistor Q_{C1} and the base of the transistor Q_{C2} simultaneously. The resistor R_{C5} is used as the collector resistor of the transistor Q_{C1} when the transistor Q_{C1} is turned on and the transistor Q_{C2} is cut off. The resistor R_{C5} is used as the base resistor of the transistor Q_{C2} when the transistor Q_{C1} is cut off and the transistor Q_{C2} is turned on.

One end of the resistor R_{C6} is connected to the independent voltage V₁, the other end is connected the collector C of the transistor Q_{C2}, the reference terminal R and the cathode K of the regulator T_{C2}. The resistor R_{C6} is used as the collector resistor of the transistor Q_{C2} when the transistor Q_{C2} is turned on, the output voltage vₒ(t)=V_{CE(sat)}. The resistor R_{C6} is used as the pull-up resistor of the regulator T_{C2} when the transistor Q_{C2} is cut off, the output voltage vₒ(t)=V_{ref}.

In general, the B-E voltage v_{BE}(t) of the transistor Q_{C1} is expressed as

$${v}_{BE} ( t ) = \frac{{v}_{o} ( t ) {R}_{C 4}}{{R}_{C 3} + {R}_{C 4}} + \frac{{i}_{C} ( t ) {R}_{C 3} {R}_{C 4}}{{R}_{C 3} + {R}_{C 4}}$$

where vₒ(t) is the output voltage of the control/modulation signal converter and i_{C}(t) is the collector current of the opto-transistor T_{R1}. From the above expression, the B-E voltage v_{BE}(t) is controlled by i_{C}(t) that means v_{BE}(t) is controlled by vᵢ(t).

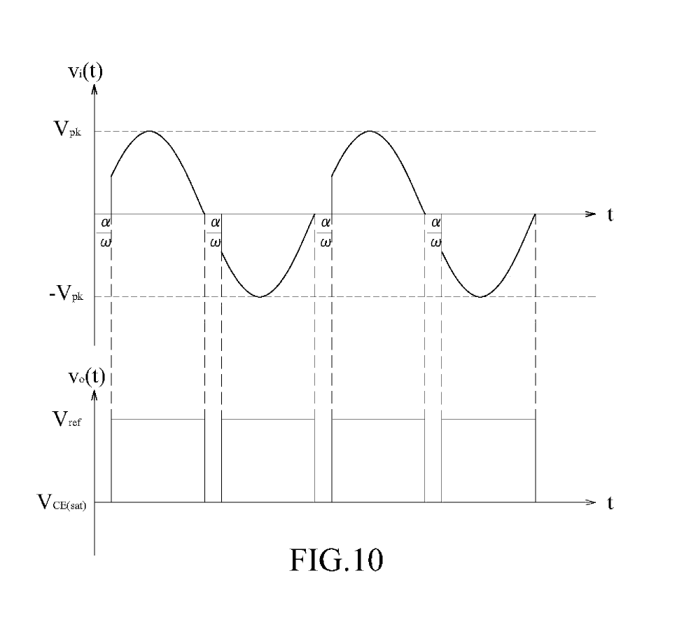

FIG. 10 shows the waveforms of the input voltage vᵢ(t) of the control signal transmitter U_{T} and the output voltage vₒ(t) of the control/modulation signal converter. During firing delay time (≦α/ω), |vᵢ(t)|<V_{F}, which is the forward voltage drop of the control signal transmitter U_{T} in the first embodiment or |vᵢ(t)|<V_{F}+2V_{f} in the second embodiment. i_{C}(t)=0, v_{BE}(t)<v_{BE(sat)} and the transistor Q_{C1} is cut off and the transistor Q_{C2} is turned on, the output voltage vₒ(t)=V_{CE(sat)}. During conduction time (α/ω)≦(π/ω), |vᵢ(t)|>V_{F} in the first embodiment or |vᵢ(t)|>V_{F}+2V_{f} in the second embodiment. i_{C}(t)=η/(|vᵢ(t)|−V_{F})/R_{T1} in the first embodiment, i_{C}(t)=η(|vᵢ(t)|−(V_{F}+2V_{f}))/R_{T1} in the second embodiment, v_{BE}(t)=v_{BE(sat)} and the transistor Q_{C1} is turned on and the transistor Q_{C2} is cut off, the output voltage vₒ(t)=V_{ref}. The waveform of the negative half period is symmetric to that of the positive half period. When the firing delay angle adjustment element R_{T1} decreases (means the firing delay angle α decreases), the root-mean-squared voltage Vᵣₘₛ increases and the PWM wave width increases. When the firing delay angle adjustment element R_{T1} increases (means the firing delay angle α increases), the root-mean-squared voltage Vᵣₘₛ decreases and the wave PWM width decreases. Therefore the AC/DC modulation conversion system is capable of converting an AC modulation signal into a DC modulation signal to modulate the controllable DC load circuits, such as to modulate the temperature of a controllable DC heater, the speed of a controllable DC motor and the lightness of a controllable DC lamp.

It is emphatically noted that the components, control signal transmitter, control signal receiver and control/modulation signal converter of an AC/DC modulation conversion system of the present invention can be constructed by discrete components, an integrated circuit or a system on chip (SOC).

While the invention has been described in terms of what are presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An AC/DC modulation conversion system comprising:
a control signal transmitter receiving an AC modulation signal and emitting a control signal;
a control signal receiver receiving said control signal; and
a control/modulation signal converter connecting to said control signal receiver, an independent voltage source, an output terminal and an output reference terminal to convert said control signal into a PWM modulation signal of said output terminal.

2. An AC/DC modulation conversion system according to claim 1, wherein said control signal transmitter communicates with said control signal receiver in magneto-coupling, electro-coupling or opto-coupling.

3. An AC/DC modulation conversion system according to claim 1, wherein said control signal transmitter and said control signal receiver are formed a bidirectional opto-coupler, said control signal transmitter comprises a firing delay angle adjustment element, a first opto-diode and a second opto-diode, said first opto-diode and said second opto-diode are connected between two input terminals of said control signal transmitter in anti-parallel, and said firing delay angle adjustment element is connected to one of said two input terminals, and said control signal receiver is an opto-transistor.

4. An AC/DC modulation conversion system according to claim 3, wherein said firing delay angle adjustment element is a constant resistor, a variable resistor, a controllable current source or the combination thereof.

5. An AC/DC modulation conversion system according to claim 1, wherein said control signal transmitter and said control signal receiver are formed a unidirectional opto-coupler, said control signal transmitter comprises a firing delay angle adjustment element, a diode bridge rectifier and an opto-diode, an anode and a cathode of said opto-diode are respectively connected to a positive electrode and a negative electrode of said diode bridge rectifier, and said firing delay angle adjustment element is connected with one of two input terminals of said diode bridge rectifier, and said control signal receiver is an opto-transistor.

6. An AC/DC modulation conversion system according to claim 5, wherein said firing delay angle adjustment element is a constant resistor, a variable resistor, a controllable current source or the combination thereof.

7. An AC/DC modulation conversion system according to claim 1, wherein said control/modulation signal converter comprises:
a first NPN bipolar junction transistor,
a collector of said first NPN bipolar junction transistor connecting with said independent voltage source via a first resistor,
an emitter of said first NPN bipolar junction transistor connecting with said output reference terminal,
a base of said first NPN bipolar junction transistor connecting with said emitter of said first NPN bipolar junction transistor via a second resistor, and
said base of said first NPN bipolar junction transistor connecting with said control signal receiver via a third resistor; and
a second NPN bipolar junction transistor,
a collector of said second NPN bipolar junction transistor connecting with said independent voltage source via a fourth resistor,
an emitter of said second NPN bipolar junction transistor connecting with said output reference terminal,
an base of said second NPN bipolar junction transistor connecting with said collector of said first NPN bipolar junction transistor, and
said collector of said second NPN bipolar junction transistor connecting with said output terminal.

8. An AC/DC modulation conversion system according to claim 7, further comprising a filter capacitor connected between said output terminal and said output reference terminal.

9. An AC/DC modulation conversion system according to claim 7, further comprising a programmable voltage regulator, wherein an reference terminal of said programmable voltage regulator is connected with an cathode of said programmable voltage regulator, said cathode of said programmable voltage regulator is connected with said output terminal and an anode of said programmable voltage regulator is connected with said output reference terminal.

10. An AC/DC modulation conversion system according to claim 1, further comprising a sinusoidal voltage chopper connected to said control signal transmitter, and generating said AC modulation signal.

11. An AC/DC modulation conversion system according to claim 1, being implemented by an integrated circuit (IC).

12. An AC/DC modulation conversion system according to claim 1, being implemented by a system on chip (SOC).

13. A dimmer being constructed by an AC/DC modulation conversion system of claim 1.
